(19) United States
(12) Patent Application Publication
(10) Pub. No.: US 2008/0177670 A1
(43) Pub. Date: Jul. 24, 2008

(54) STATISTICAL SYSTEM TO TRADE SELECTED CAPITAL MARKETS

(75) Inventor: William Joseph Reid, Fairview, TX (US)

Correspondence Address: NETP&L, INC., 1385 SAGEBROOK DRIVE, FAIRVIEW, TX, 75069, US

(73) Assignee: William Joseph Reid, Fairview, TX (US)

(21) Appl. No.: 11/624,296

(22) Filed: Jan. 18, 2007

(51) Int. Cl. G06Q 40/00

(52) U.S. Cl. 705/36 R

(57) ABSTRACT

A financial investment trading system where trading signals are automatically generated by a computer system.

### BACKGROUND OF INVENTION

The current art of financial investment management involves the forecasting of trading opportunities for the various financial markets in which one may invest. The need to perform this difficult task arises from the idea that investors will be most satisfied by maximizing the expected returns on their investments which requires extensive knowledge and is best carried out by knowledgeable practioners or by using the art of this invention to statistically process the basis for the required knowledge. Knowledge is the product of information and communication and information can be both current and historical. A trading system must then be able to effectively process information and accurately communicate the trades.

In forecasting investment returns, analysis can take one of two broad approaches. The first, a method of evaluating investment vehicles by relying on the assumption that market data, such as charts of price, volume, and open interest, can help predict future (usually short-term) market trends. Unlike fundamental analysis, the intrinsic value of the investment is not considered. Technical analysts believe that they can accurately predict the future price of an investment by looking at its historical prices and other trading variables. Technical analysis assumes that market psychology influences trading in a way that enables predicting when a investment will rise or fall. For that reason, many technical analysts are also market timers, who believe that technical analysis can be applied just as easily to the market as a whole as to an individual investment.

The second is a method of security valuation which involves examining the company's financials and operations, especially sales, earnings, growth potential, assets, debt, management, products, and competition. Fundamental analysis takes into consideration only those variables that are directly related to the company itself, rather than the overall state of the market or technical analysis data.

Statistical analysis has not been a general market analysis method. Statistical analysis refers to a collection of methods used to process large amounts of data. Statistical analysis may be particularly useful when dealing with noisy data. For large amounts of data a computer analysis tool is necessary.

One tool that has been applied to statistical analysis is a non-statistical neural engine.

Non-Statistical work in market investment forecasting done by Edward Gately in his book Neural Networks for Financial Forecasting (John Wiley & Sons, c. 1996) shows the application of neural networks to financial forecasting. In his book, Gately describes the general methodology required to build, train, and test a neural network using commercially-available software. The probability of correctly predicting investment market performance from historical data in Gately's book, summarized in Table 1, compares non-statistical neural network and regression forecasting methods on the same historical data.

TABLE 1

| Model | Market Rise Success | Market Fall Success |
|---|---|---|
| Neural Network | 93.4% | 88.3% |
| Regression | 72.5% | 57.7% |

Many published works have further developed Gately's original work and showed even with these neural network results it did not mean trading success.

The Gately study predicted the next 10 days of the S&P 500 index using the previous 1700 days of history as the training. While statistical regression analysis adds some value in a forecast, it is close to the results of a coin flip in predicting a market fall.

A neural network is an interconnected assembly of simple processing elements, units or nodes, whose functionality is loosely based on the animal neuron. The processing ability of the network is stored in the inter-unit connection strengths or weights, obtained by a process of adaptation to, or learning from, a set of training patterns.

Rather than using a digital model, in which all computations manipulate zeros and ones, a neural network works by creating connections between processing elements—the computer equivalent of neurons. The human brain contains approximately 10¹⁰ interconnected neurons, creating a massively parallel computational capability that can store 100 trillion facts and handle 15,000 decisions a second.

In a real-world system, such as a stock or futures market, the nature and structure of the state space is obscure, so the actual variables that contribute to the state vector are unknown or debatable. The task for a time series predictor can therefore be rephrased: given measurements of one component of the state vector of a dynamic system, is it possible to reconstruct the (possibly) chaotic dynamics of the phase space and thereby predict the evolution of the measured variable?

Most work in neural networks has concentrated on forecasting future developments of the time series from values of x up to the current time. Neural networks can be used to forecast future developments by a method often called a sliding window. This can be formally stated as: find a function f such as to obtain an estimate of x at time t+d, from the N time steps back from time t, so that:

x(t+d)=f(x(t), x(t=1, x(t−1), . . . , x(t−N+1))

x(t+d)=f(y(t))

where y(t) is the N-ary vector of lagged values. Normally d will be one, so that forecasting will be the next value of x. Most research and application has been to forecast the next value in a time series, like the next value of the S&P 500 index, given today's value and daily values for the past two years.

The neural nets defined in this way can be simulated using commercially available software packages such as Neural Solutions (marketed by Neural Dimensions, Inc., Gainesville, Fla. 32609), Brain Maker Professional (marketed by California Scientific Software, Nevada Calif. 95959), Neural Works Professional II/Plus (from Neural Ware Inc., Carnegie, Pa. 15106), Neuroshell 2 (distributed by the Ward Systems Group, Frederick, Md. 21702), and others. Several applications of neural nets to the domain of finance are already known in the art.

U.S. Pat. No. 5,761,442 to Barr et al. discloses a data processing system and method for selecting financial investment and constructing an investment portfolio based on a set of artificial neural networks designed to model and track the performance of each investment in a given capital market and output a parameter related to the expected risk adjusted return for the investment compared to a market index. The data processing system receives input from the capital market and periodically evaluates the performance of the investment portfolio, rebalancing it whenever necessary to correct performance degradations. Dean's system is a portfolio management system comparing investment financial investment to a market index for optimizing portfolio return. Dean does not teach a statistical method for selecting a Trading Signal for an individual financial investment.

U.S. Pat. No. 5,109,475 to Kosaka et al. discloses a neural network for selection of time series data. This method is illustrated in a particular application to the problem of stock portfolio selection. In the first step of the proposed method, certain characteristics for each investment are calculated from time series data related to the investment. The characteristics to be computed include the historical risk (variance and co-variance) and the return. The Kosaka system is primarily a storage system for storing time series and an analysis of time series, with no Trading Signal for individual investment. Koska does not teach a statistical method for selecting a Trading Signal for an individual financial investment.

U.S. Pat. No. 2,253,081 to Hatano et al. discloses a neural net for stock selection using price data as input. The main idea of the proposed system is to calculate runs (sequences) of price trends, increases, and decreases, using a point-and-figure chart and using the maximum and minimum values from the chart to make a time-series prediction using a neural network. The Hatano system is a neural model, one of many such models, and has no Trading Signal for individual investment. Hatano does not teach a statistical method for selecting a Trading Signal for an individual financial investment.

The above-described financial systems do not use a statistical application of neural nets for financial investment.

### SUMMARY OF INVENTION

The art of the present invention describes a system that can be structured to one hundred percent statistically determined signals to trade a selected market profitability. The art of the present invention then determines a trading method and a method and means to select specific markets that can be automatically traded.

The invention then describes how the extensive knowledge required for successful investment may be automatically statistically determined. Effectively processing this knowledge uses non-statistical tools including neural networks and genetic servers.

To automatically trade a financial market the historical pricing data needs to provide information content sufficient to forecast future pricing actions. A comprehensive study of financial markets Nonlinear Dynamics, Chaos and Instability was published by MIT Press in 1991 by Brock, Hsieh and LeBaron. This study categorized markets as Random—no forecasting possible, Correlated—long term forecasting possible and Chaotic—short term and long term forecasting possible. Over a 10 year period the US Treasury Note rate market was random; the Fed Funds Rate market and stock market were correlated; and only the Forex market was Chaotic.

Chaos science is finding a way through disorder and external events, to arrive at a direction. Using the Bird Flu as an example, do reporters get answers that say “Look at history” or “Look at the previous outbreaks”? No. They get answers like We don't know what it will be like when it gets here” that is Chaos science.

Chaos science says when new information arrives it may not fit existing models or may require a new model. Epidemics, weather and the formation of new planets are Chaos science. This science is required to handle the new information constantly affecting the short term FOREX market. Other markets or approaches to other market to fit the Chaos science can also be developed using the methods of the present invention.

FIG. 1 shows a neural network in the desired architecture in the art of the present invention. This is one of many ways a neural network may be architected. The Desired Signal is the signal that you would like to match with the Input Signal. The Error signal and Training network can adjust the parameters of the Input Signal to best match the Desired Signal. The Desired Signal will be the historical pricing of the market we are trading with a very unique characteristic. It will look forward from any given time and figure out the action it should have taken in the past to yield the best result. The result is that the Desired Signal will be one hundred percent accurate and make substantial profits because it knows the future.

FIG. 2 shows the Desired Signal trading decisions superimposed on the historical market pricing chart of a specific investment. We show these trading decisions as small triangles superimposed on the market price data chart. A solid upward triangle will indicate a BUY trading decision. A solid downward triangle will indicate a SELL trading decision. Hollow or unfilled triangles are exits from a BUY or SELL trade. Because of the ability to look forward in time the trading decisions of the Desired Signal are excellent.

The present invention provides the method and means to develop an Input Signal automatically that can be optimized to provide a sufficient match to the Desired Signal to generate meaningful profits.

Indicators are mathematical formulas that use the market price data to determine trading decisions. The Input Signal will be made up of a group of indicators. FIG. 3 describes the construction on the Input Signal of FIG. 1. The markets have two major characteristics. First the market moves in cycles of varying periodicity. Elliott Waves and Fibonacci Time cycles are very popular technical indicators. Secondly the market moves in long upward or downward trends and in short choppy ranges. Many indicators do well in trending market and a few do well in ranging markets. Market technicians believe the market trends thirty percent of the time and ranges seventy percent of the time.

The first step is to select and design a sufficient number of indicators to cover the market. To get a statistically significant result these indicators must adequately cover the movement space of the market. Research and testing indicated existing indicators could cover about seventy percent of the market movement space. While existing indicators covered basic technical analysis concepts the areas of profitability flow analysis and money flow were lacking. Mathematical methods to translate from frequency cycles to price sequence flow were also designed to adequately handle the market movement space.

The top part of the FIG. 4 shows a typical market price curve over most of a two month period in 2006.

The lower part of the FIG. 4 shows one of the most popular technical indicators (MACD). Generally technicians trade the MACD when it crosses zero but you can visualize that is not very successful.

The second step of FIG. 3 is to train the indicators to match the Desired Signal of FIG. 1. The key to this step is to have enough samples to adequately train the signal but not so many samples to over-train the signal. FIG. 1 illustrates that the Input Signal has variables that can be varied to produce the desired result. The conventional wisdom in neural networks is that the ratio of the training samples to indicator variable count has to be greater than ten and less than one hundred.

Once the indicators are trained and results known the third step of FIG. 2 will select the best set of those indicators to use as the Trading Signal. Now the training period is fairly long, maybe as much as one year, bur we want an indicator selection period much shorter and nearer the actual time we will trade with that signal.

In the fourth step of FIG. 3 we will structure the training and testing period so that the Trading Signal will be selected over a period that is forty percent trained and sixty percent untrained, but tested, and is the time period closest to actual trading. In the fourth step we will combine the indicators selected in an optimization method that yields the best total result over that period. That optimized combination yields the Trading Signal.

### BRIEF DESCRIPTION OF DRAWINGS

FIG. 1 illustrates a neural networks model for matching a desired signal.

FIG. 2 shows a typical market pricing history and a popular technical indicator.

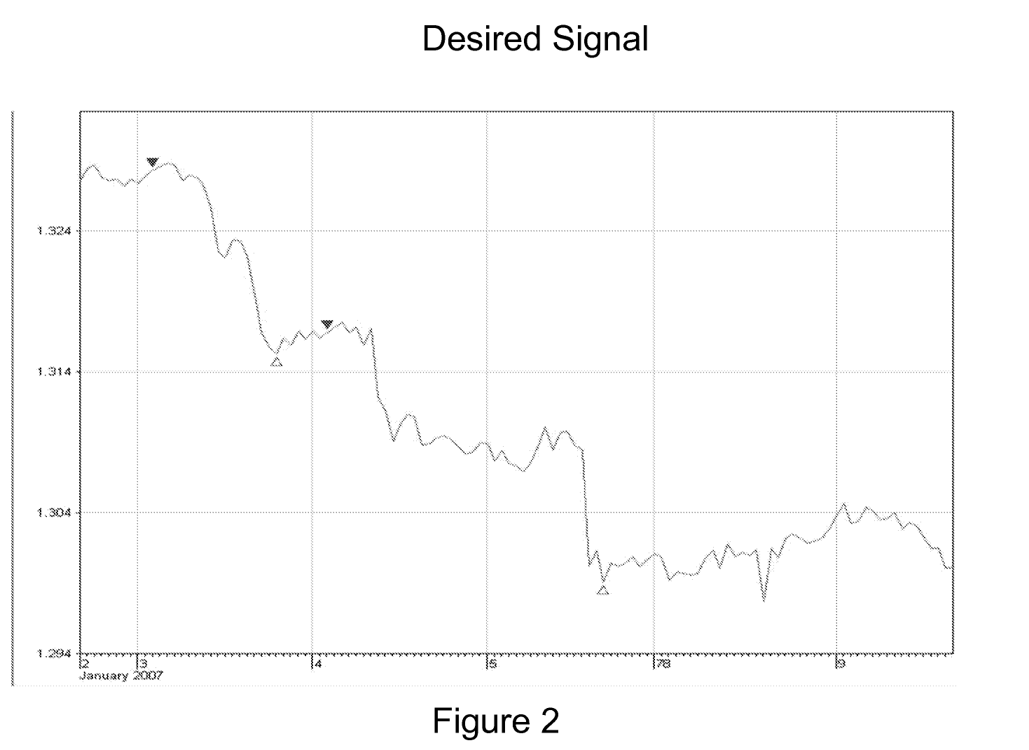

FIG. 3 shows a the Desired Signal of a market price chart.

FIG. 4 describes the construction on the Input Signal of FIG. 1.

FIG. 5 shows the results of trading the pair General Motors/Ford.

FIG. 6 shows the results of trading the pair Wal-Mart/Target.

FIG. 7 shows the results of training by the neural engine.

FIG. 8 shows the neural engine training sequence.

FIG. 9 shows the Trading Signal training structure.

### DETAILED DESCRIPTION

Selecting a Market

To automatically trade a financial market the historical pricing data needs to provide information content sufficient to forecast future pricing actions. A comprehensive study of financial markets Nonlinear Dynamics, Chaos and Instability was published by MIT Press in 1991 by Brock, Hsieh and LeBaron. This study categorized markets as Random—no forecasting possible, Correlated—long term forecasting possible and Chaotic—short term and long term forecasting possible. Over a 10 year period the U.S. Treasury Note rate market was random; the Fed Funds Rate market and stock market were correlated; and only the Forex market was Chaotic.

Chaos, with reference to mathematics and chaos theory, refers to an apparent lack of order in a system that nevertheless obeys particular laws or rules; this understanding of chaos is synonymous with dynamical instability, a condition discovered by the physicist Henri Poincare in the early 20th century that refers to an inherent lack of predictability in some physical systems. The two main components of chaos theory are the ideas that systems—no matter how complex they may be—rely upon an underlying order, and that very simple or small systems and events can cause very complex behaviors or events. This latter idea is known as sensitive dependence on initial conditions, a circumstance discovered by Edward Lorenz (who is generally credited as the first experimenter in the area of chaos) in the early 1960s.

Chaos Definition. The time series (at) has a C² deterministic chaotic explanation if there exists a system (h,F,xₜ) such that a=h(xₜ), xₜ₊₁=F(xₜ), x(0)=xₒ, where h:Rⁿ→R¹, F:Rⁿ→Rⁿ are both twice continuously differentiate, i.e., C². Furthermore we require that F have an ergodic invariant measure M that is absolutely continuous with respect to Lebesque measure. (This just means we can do a time series analysis) One computes the measure of a set A by counting the long-run fraction of time a solution x(t,x₀) of xₜ₁=F(xₜ),x(0)=Xo spends in A. Ergodicity, the property that all parts of the state space are visited by a typical solution x(t,x₀), ensures that the long-run fraction of time spent in A is independent of the initial condition x₀. This definition of “chaos” requires that the largest Lyapunov exponent, L, of F be positive.

Weather is a Chaos science and we all know that weather forecasting was very unreliable ten years ago but with large investment and mathematical and scientific study it has improved rapidly. Weather then demonstrates Nonlinear Dynamics, Chaos and Instability's concept of Chaos where it does offer the possibility of both short and long term forecasting. Mathematics and science have provided this understanding.

The stock market was identified as correlated—correlated to inflation, jobs, oil and many other factors. These factors economists can understand and forecast only in the long term. They cannot predict these correlation factor changes in the short term. Some real world factors can be observed besides the mathematics in Chaos markets. The central banks tightly control the short duration swing of Forex. You would not want to exchange dollars on Monday in Europe and get a significantly lower exchange back on Friday. This is called variance in mathematics. Forex tends to have a constant variance. The stock market has no such controls.

In Table 2 looking at the top 20 U.S. mutual fund's performance in 2005 we can see even the most skilled economists and professional traders have trouble on short term investment methods. These are firms with hundreds of economists and thousands of analysts.

TABLE 2

| | Total | 1 yr. | 3 yr. | 5 yr. |
|---|---|---|---|---|
| Ranked by Total assets | Assets | Return (%) | Return (%) | Return (%) |
| American Funds Invmt Co of Amer A | $65.06 B | −0.89 | 4.83 | 2.36 |
| American Funds Washington Mutual A | $63.23 B | −1.43 | 3.85 | 5.32 |
| American Funds Grth Fund of Amer A | $60.84 B | −1.83 | 4.88 | −1.81 |
| Dodge & Cox Stock | $44.91 B | 0.12 | 10.43 | 12.37 |
| American Funds Inc Fund of Amer A | $43.84 B | −1.37 | 8.93 | 9.21 |
| American Funds EuroPacific Gr A | $38.22 B | 0 | 10.61 | −1.06 |
| American Funds Capital Inc Bldr A | $34.58 B | −1.66 | 10.72 | 10.85 |
| American funds New Perspective A | $33.81 B | −2.2 | 7.9 | 0.45 |
| American Funds American Balanced A | $30.00 B | −1.37 | 6.13 | 9.01 |
| American Funds Capital World G/I A | $29.41 B | 0.08 | 13.54 | 7.35 |
| American Funds Fundamental Invs A | $21.76 B | −0.62 | 6.43 | 1.7 |
| Dodge & Cox Balanced | $21.73 B | −0.09 | 9.8 | 11.34 |
| American Century Ultra Inv | $20.23 B | −4.92 | 0.94 | −8.28 |
| American Funds Bond Fund of Amer A | $16.20 B | −0.98 | 7.5 | 7.03 |
| Davis NY Venture A | $15.82 B | 0.07 | 7.46 | 1.79 |
| American Funds Amcap A | $13.35 B | −2.78 | 4.13 | 1.38 |
| American Funds American Mutual A | $13.19 B | −0.87 | 4.69 | 7.13 |
| American Funds Smallcap World A | $11.45 B | −0.13 | 10.38 | −3.73 |
| Fidelity | $10.44 B | −1.54 | 2.15 | −4.27 |
| Average | | −1.18 | 7.12 | 3.59 |

However, the Forex market is not the only market that can be treated as Chaotic. One way to make the stock market Chaotic, rather than correlated, is to remove the correlation. One way to do this is with pair trading. Pair trading, also known as statistical arbitrage or spread trading is a strategy that allows the trader to capture anomalies, relative strength or even fundamental differences on two stocks or baskets while maintaining a market neutral position. The key to the strategy is simply finding correlated stocks (preferably NYSE mid and large capitalized stocks), and developing the pair Stock₁/Stock₂ Like the currency pairs you are always long one stock and short the other. Since they are each correlated stocks to the same correlation factors the correlation has been divided out.

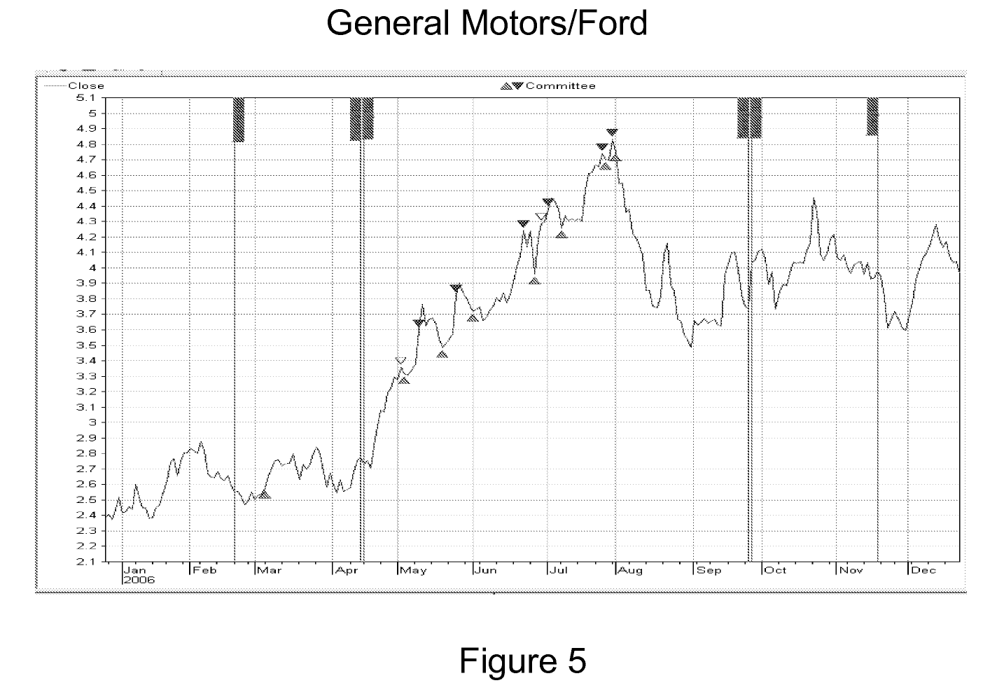

FIG. 5 show the pair General Motors/Ford which is the GM closing stock price divided by the Ford closing stock price. Actually since many indicators used High, Low, Open and Close prices it is each of these GM last trade prices divided by the Ford last trade stock prices.

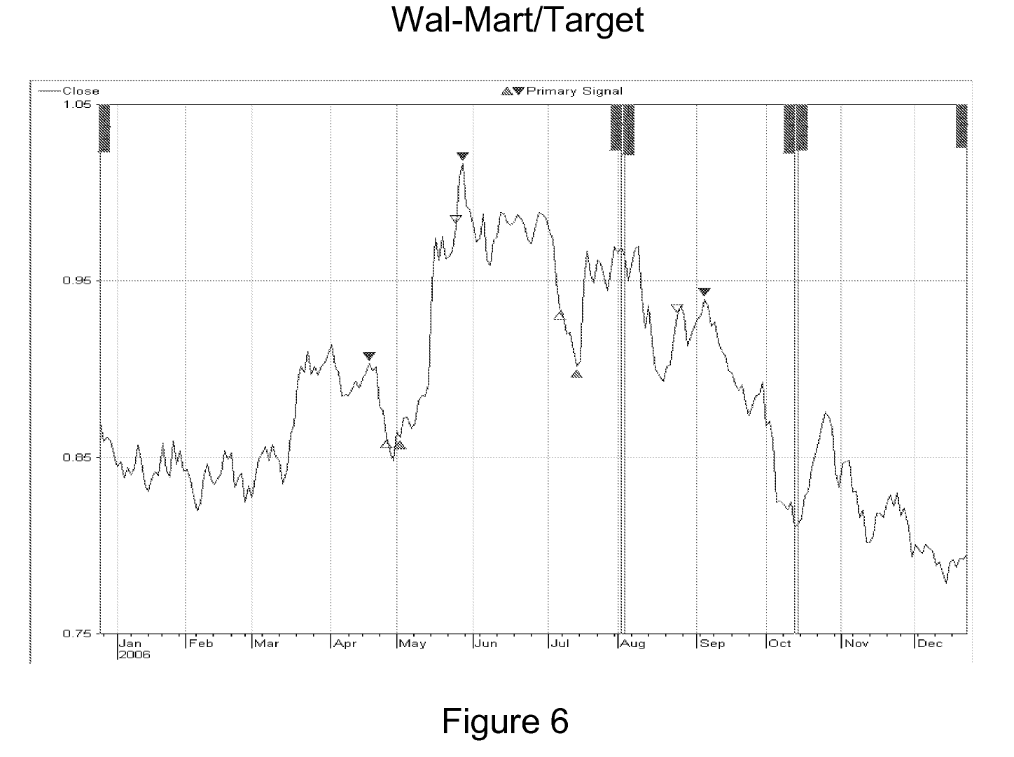

FIG. 6 show the pair Wal-Mart/Target which is the four Wal-Mart last trade prices divided by the four Target last trade prices. Even though we have divided out general market fluctuations we still see the relative strengths and weakness in the market of the companies and also see the delta changes in correlations between the companies.

The Market Selection embodiment of this invention has three major elements:
1. The definition of “chaos” requires that the largest Lyapunov exponent, L, of F be positive.
2. Forex tends to have a constant variance. The stock market has no such controls.
3. Correlation and market variance can be divided out of highly correlated stock market pairs by dividing Stock₁ by Stock_{2.}

Selecting a Trading Signal

This invention uses a non-statistical neural network, which is an interconnected assembly of simple processing elements, units or nodes, whose functionality is loosely based on the animal neuron. The processing ability of the network is stored in the inter-unit connection strengths, or weights, obtained by a process of adaptation to-or learning from-a set of training patterns. Rather than using a digital model in which all computations manipulate zeros and ones, a neural network works by creating connections between processing elements, which are the computer equivalent of neurons. The organization and weights of the connections determine the output.

The Background section described a number of applications of a neural network to forecast the future value of a stock or index. This is one application of a neural networks. Another application is pattern matching where inputs are compared against a pattern and the Error signal is the output. Every major hospital in America has this neural application running on heart attack patient information.

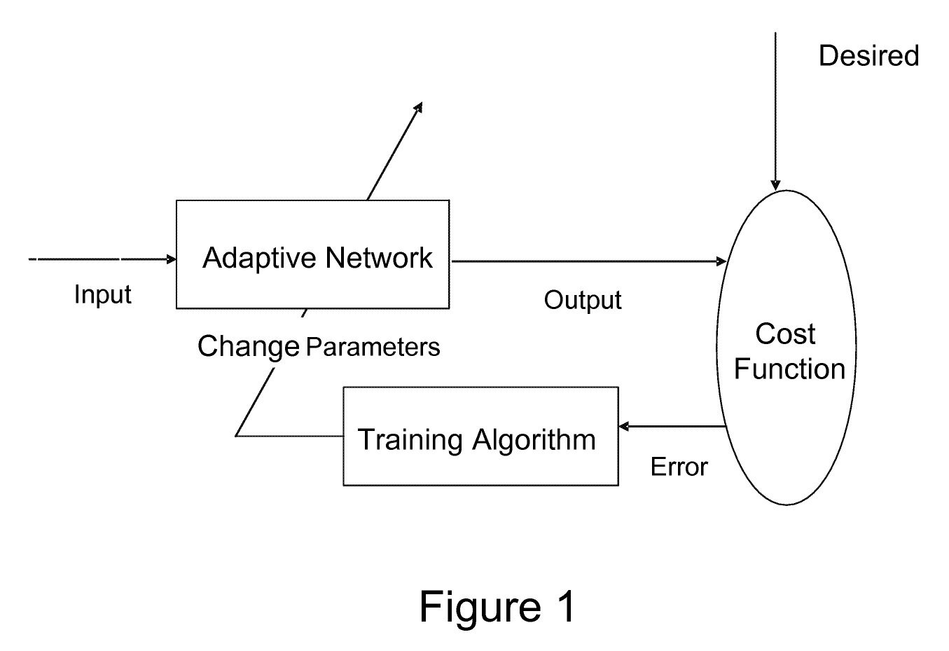

We will use a pattern matching application of a neural engine where the pattern to be matched is a Desired Signal. FIG. 1 shows a neural network in the desired architecture in the art of the present invention. The Desired Signal is the signal that you would like to match with the Input Signal. The Error signal and Training network can adjust the parameters of the Input Signal to best match the Desired Signal.

The Desired Signal will be based on the historical pricing of the market we are trading with a very unique characteristic. It will be able to look forward from any given time and figure out the action it should have taken in the past to yield the best result. The result is the Desired Signal pattern which will be one hundred percent accurate and make substantial profits because it knows the future. The Desired Signal is allowed to look ahead by ten hours and has a minimum profit of 0.5 percent and a max drawdown before a minimum profit of 0.5 percent with 100:1 leverage.

The present invention provides the method and means to develop an Input Signal automatically that can be updated to provide a sufficient match to the Desired Signal to generate meaningful profits.

Indicators are mathematical formulas that use the historical market price data to determine trading decisions. The Input Signal will be made up of a group of indicators. Indicators are divided into two major groups: trend following/lagging and momentum/leading. Lagging indicators reflect what prices are doing now, or in the recent past, and are useful in a trending market. A moving average is an example of a lagging indicator. Leading indicators attempt to anticipate future price action, and oscillators such as the Commodity Channel Index are examples. In an economic context, an indicator could be a measure such as Gross Domestic Product that may be used to forecast future economic trends.

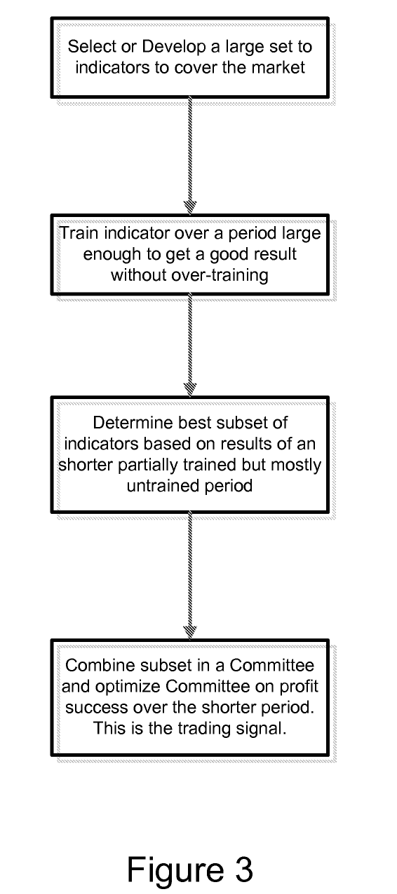

FIG. 3 describes the construction on the Input Signal of FIG. 1. The markets have two major characteristics. First the market moves in cycles of varying periodicity. Elliott Waves and Fibonacci Time cycles are very popular technical indicators. Secondly the market moves in long upward or downward trends and in short choppy ranges. Many indicators do well in trending market and a few do well in ranging markets. Market technicians believe the market trends thirty percent of the time and ranges seventy percent of the time.

The first step is to select and design a sufficient number of indicators to cover the market. To get a statistically significant result these indicators must adequately cover the movement space of the market.

Research and testing indicated existing technical analysis indicators could cover about seventy percent of the market movement space.

There is a broad array of existing technical analysis indicators which can be generally described in Table 3.

TABLE 3

| Indicator Type | Description |
|---|---|
| Moving Average | Suitable for long trend signals. The delay in the |
| | average may fail in short trends. |
| Changes in the High, Low, Open Close | Technicians have noted the close tends to be |
| | nearer the high when trending up and the close |
| | is nearer the low when trending down. |
| Oscillator | Subtracts a long term moving average from a |
| | shorter term moving average. This |
| | approximates a differentiator and becomes a |
| | peak and valley detector. |
| Accumulation/Distribution | Determine the momentum of a financial data |
| | series using the trading volume to assess the |
| | significance of daily price movement. |
| Filters | Determine whether a field is in a trending or |
| | trading phase by analyzing the difference |
| | between the highest and lowest values versus |
| | daily fluctuations. |
| Momentum | Determines the internal momentum of a field |
| | using the number of upward and downward |
| | price changes over a given period of time. |

While existing indicators covered basic technical analysis concepts, the areas of profitability flow analysis and money flow were lacking. Mathematical methods to translate from frequency cycles to price sequence flow were also designed to adequately handle the market movement space.

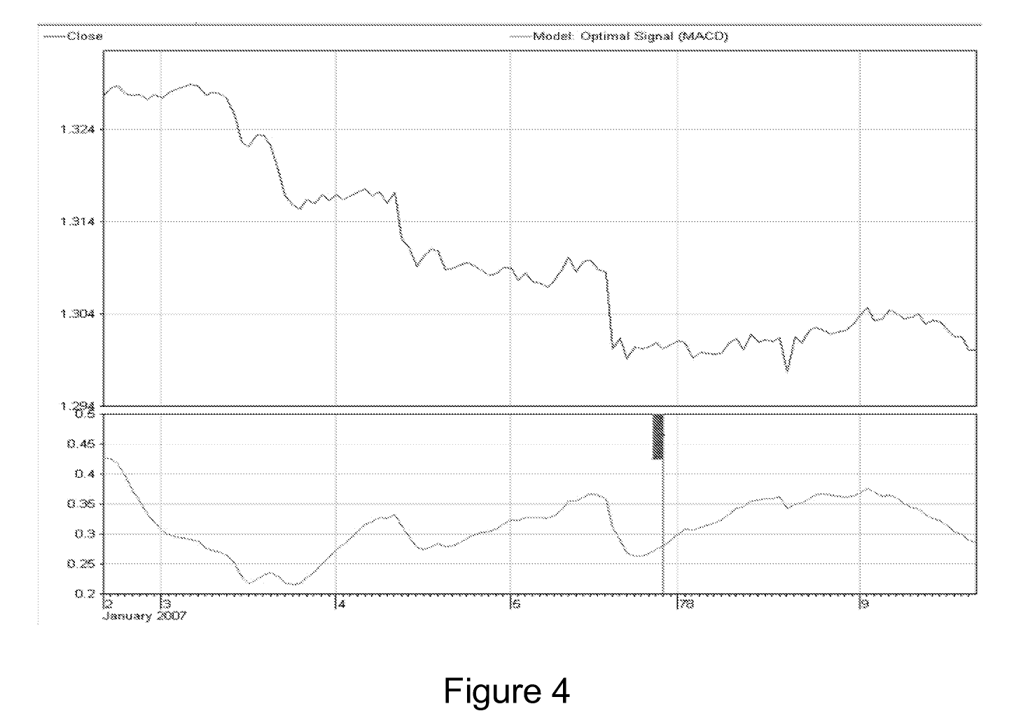

The top part of FIG. 4 shows a typical market price curve over most of a two month period in 2006. The lower part of FIG. 4 shows one of the most popular technical indicators (MACD oscillator, based on entries in Technical Analysis From A To Z by Steven B. Achelis). Generally technicians trade the MACD when it crosses zero but you can visualize that is not very successful.

To adequately cover the market movement space new indicators were designed. These new indicators are shown in Table 4.

TABLE 4

| Indicator Type | Description |
|---|---|
| Profit Flow | Over the time period of market pricing, given a |
| | selected direction, the movement will generate |
| | profit and losses. This profit flow must be over |
| | an adequate period to make this judgment. This |
| | indicator has a non-linear decision process for |
| | initial conditions. |
| Optimal Money Flow | Existing Accumulation/Distribution indicators |
| | have two major problems. First they cannot |
| | handle gaps often in pricing movements. |
| | Secondly they do not handle the double peaks |
| | and double valleys quite prevalent in pricing |
| | movements. These indicators have a non-linear |
| | pattern matching function added to |
| | Accumulation/Distributions indicators |
| Time Cycles | Markets often move in cycles which are in the |
| | frequency domain while price samples are in |
| | the time domain. Translating frequency to time |
| | domain uses digital filtering and impulse filters. |
| | These indicators are non linear as domain |
| | translation is not bi-lateral. |
| Derivative Functions | Combinations of 2^{nd} and 3^{rd} order derivatives of |
| | existing linear functions. Corrects the issue that |
| | major leading indicators like Relative Strength |
| | Indicator, developed by J. Welles Wilder and |
| | discussed in his book New Concepts in Technical |
| | Trading, and Stochastic Oscillator based on an |
| | entry in Technical Analysis From A To Z by |
| | Steven B. Achelis, make wrong decisions in a |
| | long trending markets. |

Designing new indicators was initially a trial and error method but developed into a methodology that seemed to match a market that has an underlying pattern to apparent randomness. One major change was that the new indicators were non-linear versus the existing linear indicators.

When using a large group of indicators that are statistically combined for trading a Chaotic market of dynamic instability market coverage of an individual indicator at any one time, or even over a significant period, are not be a good test or measurement. Actual performance of the Trading Signal in the Selected Market will be the accurate and true test and measurement.

The second step of FIG. 3 is to train the indicators to match the Desired Signal of FIG. 1. Key in this step Is to have enough samples to adequately train the signal but not so many samples as to over-train the signal. FIG. 1 illustrated that the Input Signal has variables that can be changed to produce the desired result. The conventional wisdom in neural networks is that the ratio of training samples to variable count has to be greater than ten and less than one hundred.

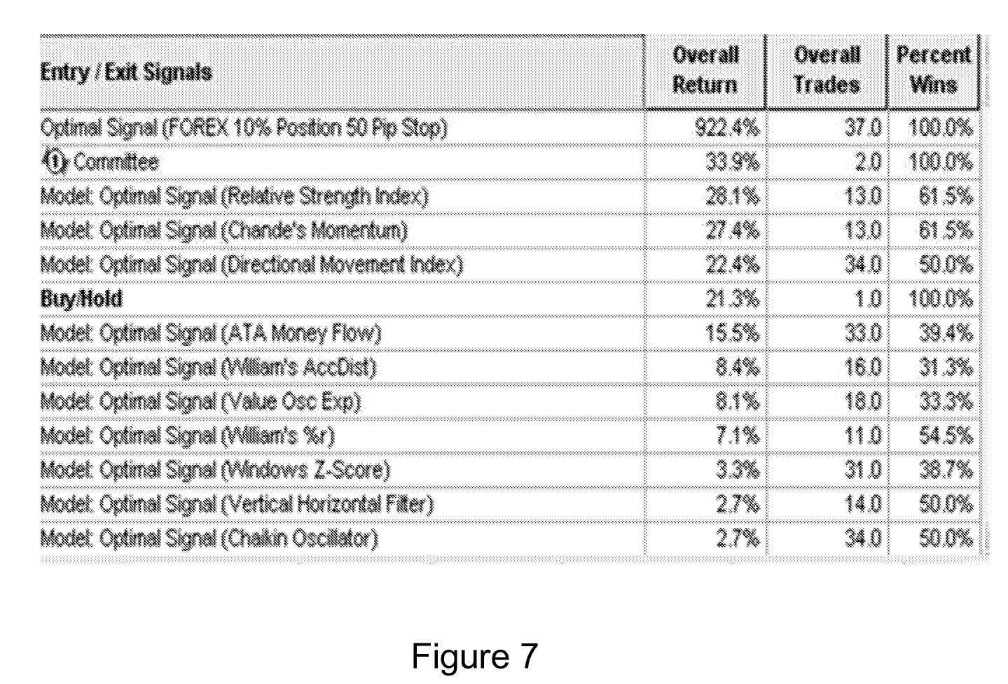

FIG. 7 shows the results of neural network training. The Optimal Signal in the first line is the Desired Signal we discussed earlier. Because of the Desired Signal's ability to look into the future the Desired Signal is 100% correct and yields a rather amazing profit. The lines starting with “Model:” are various indicators of the type described in Table 3 that are grouped together to make up the Input Signal of FIG. 1. Each indicator is trained individually.

Once the indicators are trained and results known the third step of FIG. 3 will select the best set of those indicators to use as the Trading Signal. The selection of best indicators starts with the neural engine design with to attempt to match the Desired Signal. Rather than just picking indicators for the profit they can yield we use a method to also control the risk or volatility. That method is the Sharpe ratio.

The Sharpe ratio was developed by Nobel Laureate William F. Sharpe to measure risk-adjusted performance. It is calculated by subtracting the risk-free rate from the rate of return for a indicator and dividing the result by the standard deviation of the indicator returns during each training cycle (Portfolio of results of each cycle)

$$= \frac{{r}_{p} - {r}_{f}}{{σ}_{p}}$$

Where:
rₚ=Expected portfolio return
r_{f}=Risk free rate
σₚ=Portfolio standard deviation

The Sharpe ratio tells us whether the returns of an indicator are due to smart investment decisions or a result of excess risk. This measurement is very useful because although one indicator can reap higher returns than its peers, it is only a good investment if those higher returns do not come with too much additional risk. The greater an indicator's Sharpe ratio, the better its risk-adjusted performance has been. The “Model:” results in FIG. 7 are returns that are Sharpe ratio optimized. We let the neural engine and the Sharpe ratio select the Indicators In the correct order that do well as the Trading Signal as shown in FIG. 6.

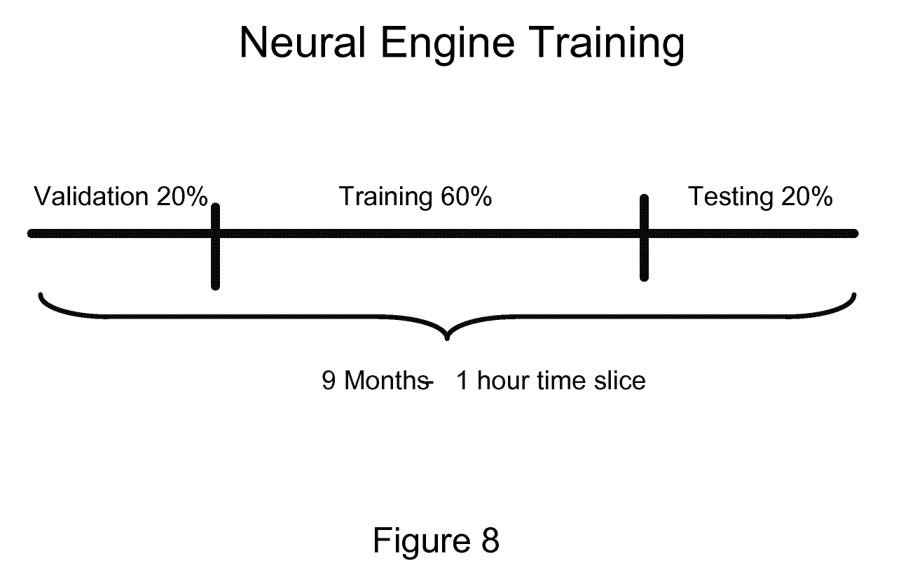

The training period as described in FIG. 8 is necessarily long to get sufficient samples, maybe as much as one year, but we want an indicator selection period much shorter and nearer the actual time we will trade with the Trading Signal.

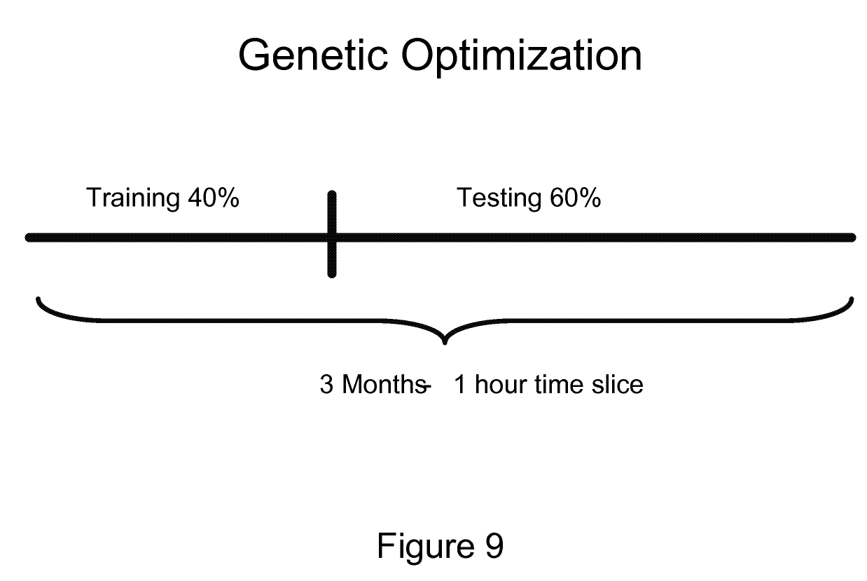

In the fourth step of FIG. 3 we will structure the training and testing period for the final selected group of indicators as described in FIG. 9. The Trading Signal will be selected over a period that is forty percent trained and sixty percent untrained, but tested. It is the time period closest to actual trading. Extensive testing has indicated that this period concept has high assurance of successfully carrying over the trained results to future untrained periods.

In the fourth step we will combine the top ten indicators into a group called a Committee. A genetic server is then used to optimize this Committee over the Genetic Optimization period of FIG. 9. The Genetic optimization determines the relative value of each indicator for a best solution and gives that indicator a weight representing that value. That optimized combination yields the single Trading Signal of those weighted indicators.

The Trading Signal embodiment of the present invention has four major elements:

Indicators necessary to adequately cover the price movement space were designed to supplement existing indicators to get a statistically significant result.

The initial indicators resulting in the Trading Signal are trained with criteria of Sharpe ratio rather than profits. The Trading Signal optimization period is selected to allow the trained indicator results to carry over to future periods. The Committee forming the Trading Signal is weighted according to its contribution to the final Trading Signal.

The above described preferred embodiment of the system and method of the present invention is merely illustrative of the principles of this invention. Numerous modifications and adaptations thereof will be readily apparent to those skilled in the art without departing from the spirit and scope of the present invention, which is defined in the following claims.

1) A computer system with software applications of one or more neural network engines and one or more genetic server software applications producing an investment market Trading Signal wherein:
a) the Trading Signal is trained by the neural network engine(s);
b) the Trading Signal is optimized by the genetic server(s);
c) the Trading Signal is automatically generated without manual selection;
d) the Trading Signal is applied in a Chaotic market where the largest Lyapunov exponent, L, of F is positive.

2) A computer system with software applications producing an investment market Trading Signal wherein;
a) a desired signal is developed by looking ahead to future dates, beyond the current processing date, to achieve the best trades possible at the current processing date;
b) a group of indicators, greater than 10, are trained by one or more neural engines to best match the desired signal;
c) this subset of indicators is automatically optimized based on relative indicator performance;
d) this subset of indicators is automatically selected to yield a Trading Signal;
e) the Trading Signal is applied in a Chaotic market where the largest Lyapunov exponent, L, of F is positive.

3) A financial investment trading system where Trading Signals are generated by a computer system wherein:
a) the Trading Signal is trained by the neural network engine(s);
b) the Trading Signal is optimized by the genetic server(s);
c) the Trading Signal is automatically generated without manual selection;
d) the Trading Signal is applied in a Chaotic market where the largest Lyapunov exponent, L, of F is positive.
